(19) United States
(12) Patent Application Publication
(10) Pub. No.: US 2009/0239597 A1
(43) Pub. Date: Sep. 24, 2009

(54) GAMING SYSTEM AND GAME CONTROL METHOD ENABLING TO BET ON A PAYOUT AMOUNT OF A PLAYER WHO WON AN AWARD ASIDE FROM A BET TO A PLURALITY OF CHARACTERS

(75) Inventor: Fumiya ABE, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 12/235,103

(22) Filed: Sep. 22, 2008

Related U.S. Application Data
(60) Provisional application No. 61/034,365, filed on Mar. 6, 2008.

(51) Int. Cl. A63F 9/24; A63F 13/00

(52) U.S. Cl. 463/6; 463/25; 463/30

(57) ABSTRACT

In a racing game, a main control unit 112 of a main controller 20 accepts a first bet on characters and a side bet. A payout for the side bet is provided in a case where the greatest payout amount among the terminals for the first bet reaches a threshold value. The payout for a side bet is determined to be of a predetermined percentage with respect to the greatest payout amount, where the percentage is determined in accordance with an amount of the side bet.

### CROSS REFERENCE TO RELATED APPLICATIONS

This application claims benefit of U.S. Provisional Application No. 61/034,365, filed Mar. 6, 2008, the entire contents of which are incorporated herein by reference.

### BACKGROUND OF THE INVENTION

1. Field of the Invention

The present invention relates to a gaming system and a game control method that enables betting on a payout amount of a player who won an award aside from a bet on a plurality of characters, in a racing game in which a plurality of characters race for a finishing order.

2. Related Art

Conventionally, racing games in which a plurality of characters races, a player bets by predicting the finishing order, and the player is awarded based on the rank of the character bet on and odds announced before the start of the race, are known. A representative example of such a racing game is a game in which the racing character is a horse, such as the horse racing game disclosed in U.S. Pat. No. 5,320,351. The racing character can be a car, other animals and the like; however, the player bets similarly by predicting the finishing order thereof.

The target of a bet can be, in a horse racing game such as the one described in U.S. Pat. No. 6,848,991: a horse of first place, horses of first and second places, a group of a predetermined number of horses including horses of first and second places, and the like; thus, almost all the horse racing games are the same as real world horse racing.

In such a case, a player who has lost a bet loses the amount they have bet; in addition, the player can only watch with anticipation other players who have won an award and be glad. This only annoys and deters the players who have lost bets numerous times.

In order to solve the aforementioned problem, the present invention provides a gaming system and a game control method in which a player can, in addition to betting on a certain character, bet on a payout amount provided to a player who won an award, thus providing various betting options and increasing the chances of winning an award, thereby arousing interest and excitement of the player.

### SUMMARY OF THE INVENTION

In a first aspect of the present invention, a gaming system is provided including: a display for displaying images relating to a racing game; first memory for storing an amount of a first bet on a result of the racing game; second memory for storing an amount of a second bet on a first payout amount determined in accordance with the result of the racing game and the first bet; a controller for executing the racing game and for determining the first payout amount and a second payout amount determined in accordance with the second bet; and a plurality of terminals for paying out at least one of the first payout amount and the second payout amount received from the controller, including an operation device for making at least one of the first bet and the second bet; and a communication network for connecting the controller and the plurality of terminals, in which the controller executes steps of: (a) receiving at least one of the amount of the first bet and the amount of the second bet from the plurality of terminals; (b) storing the amount of the first bet in the first memory or the amount of the second bet in the second memory in accordance with the step (a); (c) executing the racing game in response to the step (b); (d) determining the first payout amount after the step (c), on the basis of a result of the racing game and the first bet stored in the first memory; (e) determining the second payout amount in a case in which the greatest first payout amount is greater than a predetermined value; and (f) submitting at least one of the first payout amount and the second payout amount to the plurality of terminals that are qualified for a payout.

In a second aspect of the present invention, the gaming system according to the first aspect is provided, in which the second payout amount is of a predetermined proportion with respect to the greatest first payout amount.

In a third aspect of the present invention, a gaming system is provided including: a display for displaying images relating to a racing game; first memory for storing an amount of a first bet on a result of the racing game; second memory for storing an amount of a second bet on a first payout amount determined in accordance with the result of the racing game and the first bet; a controller for executing the racing game and for determining the first payout amount and a second payout amount determined in accordance with the second bet; and a plurality of terminals for paying out at least one of the first payout amount and the second payout amount received from the controller, including an operation device for making at least one of the first bet and the second bet; and a communication network for connecting the controller and the plurality of terminals, in which the controller executes steps of: (a) receiving at least one of the amount of the first bet and the amount of the second bet from the plurality of terminals; (b) storing the amount of the first bet in the first memory or the amount of the second bet in the second memory in accordance with the step (a); (c) executing the racing game in response to the step (b); (d) determining the first payout amount after the step (c), on the basis of a result of the racing game and the first bet stored in the first memory; (e) determining a value of a predetermined proportion with respect to the greatest first payout amount to be the second payout amount; and (f) submitting at least one of the first payout amount and the second payout amount to the plurality of terminals that are qualified for a payout.

In a fourth aspect of the present invention, a gaming system is provided including: a display for displaying images relating to a racing game; a plurality of terminals for paying out at least any one of a first payout amount for a first bet and a second payout amount for a second bet, the plurality of terminals including an input device for inputting at least any one of: the first bet on a result of the racing game; and the second bet on a result of the first bet together with a designation of a bet target terminal thereof; first memory for storing the amount of the first bet for each of the plurality of terminals; second memory for storing the amount of the second bet and information regarding the bet target terminal for each of the plurality of terminals; a controller for executing the racing game and determining the first payout amount and the second payout amount; and a communication network for connecting the controller and the plurality of terminals, in which the controller executes steps of: (a) receiving at least one of the amount of the first bet and the amount of the second bet together with information regarding the bet target terminal; (b) storing the amount of the first bet in the first memory and the amount of the second bet together with the information regarding the bet target terminal in the second memory, in accordance with the operation of the step (a); (c) executing the racing game in response to the step (b); (d) determining the first payout amount after the step (c), on the basis of a result of the racing game and the first bet stored in the first memory; (e) in a case in which a terminal qualified for the first payout amount is the bet target terminal, determining the second payout amount for a terminal having selected the bet target terminal, on the basis of the first payout amount for the bet target terminal and the amount of the second bet placed by a terminal selecting the bet target terminal; and (f) submitting at least one of the first payout amount and the second payout amount to the plurality of terminals that are qualified for a payout.

In a fifth aspect of the present invention, the gaming system according to the fourth aspect is provided, in which the second payout amount is of a predetermined proportion with respect to the first payout amount for the bet target terminal.

In a sixth aspect of the present invention, a method is provided for controlling a game including: a display for displaying images relating to a racing game; first memory for storing an amount of a first bet on a result of the racing game; second memory for storing an amount of a second bet on a first payout amount determined in accordance with the result of the racing game and the first bet; a controller for executing the racing game and for determining the first payout amount and a second payout amount determined in accordance with the second bet; and a plurality of terminals for paying out at least one of the first payout amount and the second payout amount received from the controller, including an operation device for making at least one of the first bet and the second bet; and a communication network for connecting the controller and the plurality of terminals, in which the method includes the following steps, executed by the controller, of: (a) receiving at least one of the amount of the first bet and the amount of the second bet from the plurality of terminals; (b) storing the amount of the first bet in the first memory or the amount of the second bet in the second memory in accordance with the step (a); (c) executing the racing game in response to the step (b); (d) determining the first payout amount after the step (c), on the basis of a result of the racing game and the first bet stored in the first memory; (e) determining the second payout amount in a case in which the greatest first payout amount is greater than a predetermined value; and (f) submitting at least one of the first payout amount and the second payout amount to the plurality of terminals that are qualified for a payout.

In a seventh aspect of the present invention, the gaming system according to the sixth aspect is provided, in which the second payout amount is of a predetermined proportion with respect to the greatest first payout amount.

In an eighth aspect of the present invention, a method is provided for controlling a game including: a display for displaying images relating to a racing game; a plurality of terminals for paying out at least any one of a first payout amount for a first bet and a second payout amount for a second bet, the plurality of terminals including an input device for inputting at least one of: the first bet on a result of the racing game; and the second bet on a result of the first bet placed by the bet target terminal, together with a designation of a bet target terminal thereof; first memory for storing the amount of the first bet for each of the plurality of terminals; second memory for storing the amount of the second bet and information regarding the bet target terminal for each of the plurality of terminals; a controller for executing the racing game and for determining the first payout amount and a second payout amount determined in accordance with the second bet; and a communication network for connecting the controller and the plurality of terminals, in which the method includes the following steps, executed by the controller, of: (a) receiving at least one of the amount of the first bet and the amount of the second bet together with the information regarding the bet target terminal; (b) storing the amount of the first bet in the first memory and the amount of the second bet together with the information regarding the bet target terminal in the second memory, in accordance with the operation of the step (a); (c) executing the racing game in response to the step (b); (d) determining the first payout amount after the step (c), on the basis of a result of the racing game and the first bet stored in the first memory; (e) in a case in which a terminal qualified for the first payout amount is the bet target terminal, determining the second payout amount for a terminal having selected the bet target terminal, on the basis of the first payout amount for the bet target terminal and the amount of the second bet placed by a terminal selecting the bet target terminal; and (f) submitting at least one of the first payout amount and the second payout amount to the plurality of terminals that are qualified for a payout.

In a ninth aspect of the present invention, the gaming system according to the eighth aspect is provided, in which the second payout amount is of a predetermined proportion with respect to the first payout amount for the bet target terminal.

### BRIEF DESCRIPTION OF THE DRAWINGS

FIG. 1 is a flow chart showing a main part of the present invention;

FIG. 2 is a perspective view showing the gaming system according to a preferred embodiment of the present invention;

FIG. 3 is a diagram showing the configuration of a gaming system according to a preferred embodiment of the present invention;

FIG. 4 is a block diagram of a main controller of the gaming system according to a preferred embodiment of the present invention;

FIG. 5 is a perspective view illustrating the appearance of the terminal device according to a preferred embodiment of the present invention;

FIG. 6 is a block diagram illustrating a terminal device according to the preferred embodiment of the present invention;

FIG. 7 is a diagram showing the main flow chart of a gaming system according to a preferred embodiment of the present invention;

FIG. 8 is a flowchart showing a side bet result processing of FIG. 7;

FIG. 9 is a diagram showing an example of the display of a liquid crystal monitor of the terminal device according to a preferred embodiment of the present invention;

FIG. 10 is a flow chart showing side bet result processing according to the preferred embodiment of the present invention; and

FIG. 11 is a diagram showing an example of the display of a liquid crystal monitor of the terminal device according to a preferred embodiment of the present invention.

### DETAILED DESCRIPTION OF THE INVENTION

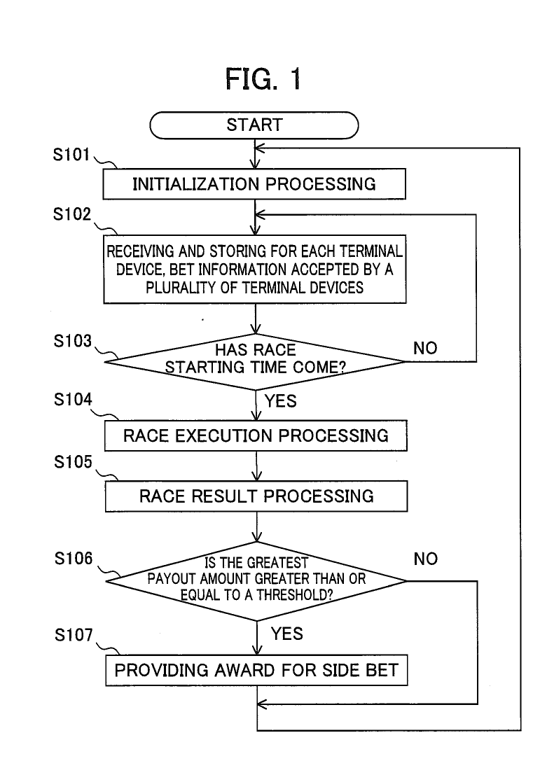

The main part of the present invention is described hereinafter with reference to FIG. 1. A main control unit 112, of a main controller 20 controlling the gaming system 1 overall according to the present invention, executes initialization processing. In other words, the main control unit 112 determines a plurality of characters participating in a race and a plurality of teams as a target of a bet, and submits the result thereof to each terminal device 30 (Step S101). In Step S102, the main control unit 112 stores the bet information received from the plurality of terminal devices 30 for each of the terminal devices 30. In Step S103, the main control unit 112 determines whether it is time for starting the race or not. In the case of a YES determination, processing is advanced to Step S104, and in the case of a NO determination, processing is advanced to Step S102. In Step S104, the main control unit 112 executes a racing game, and then advances to Step S105. In Step S105, the main control unit 112 determines an award for each of the plurality of characters based on a result of the racing game, and then advances to Step S106. In Step S106, the main control unit 112 determines whether the greatest payout amount given to the terminal devices 30 is at least a threshold value or not. In the case of a YES determination, processing is advanced to Step S107, and in the case of a NO determination, processing is advanced to Step S101. In Step S107, the main control unit 112 determines a side bet payout, and submits information regarding the side bet payout as an award provided to each of the terminal devices 30 having placed a side bet.

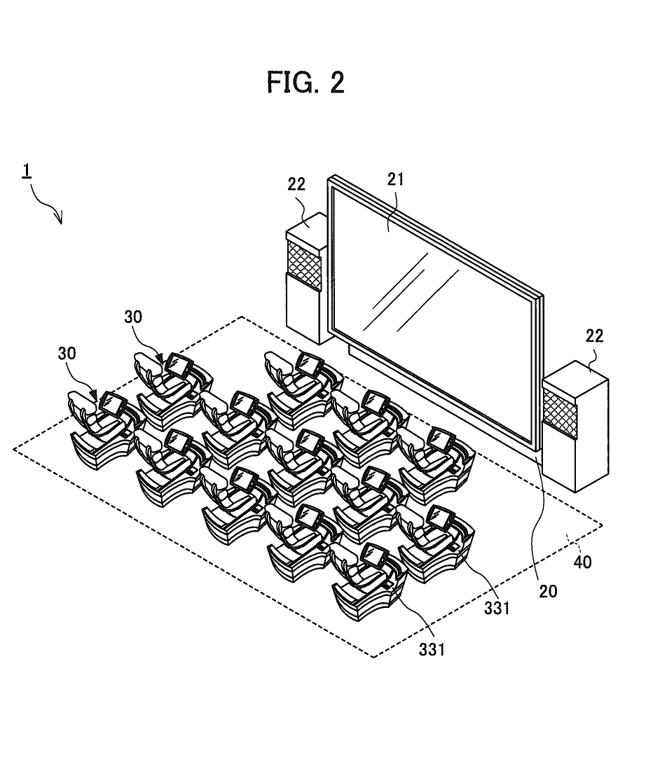

FIG. 2 is a perspective view showing an appearance of a gaming system 1 including a plurality of terminal devices 30. The gaming system 1 is a multi-player gaming system for a multi-player-type horse racing game, in which a plurality of players can participate, including a plurality of terminal devices 30 and a main controller 20, which is a controller having a large main display device 21.

The main controller 20 includes and controls the main display device 21 and speaker devices 22 installed on both sides of the main display device 21.

The main display device 21 is a large projection display device. The main display device 21 displays an image of a plurality of racehorses racing, a result of a race, and the like, in response to control by the main controller 20. On the other hand, a sub display device included in each terminal device 30 displays odds information for each racehorse, information related to a bet made by the players themselves, and the like. It should be noted that a large projection display device is used in the present embodiment; however, the present invention is not limited thereto and any large monitor can be used.

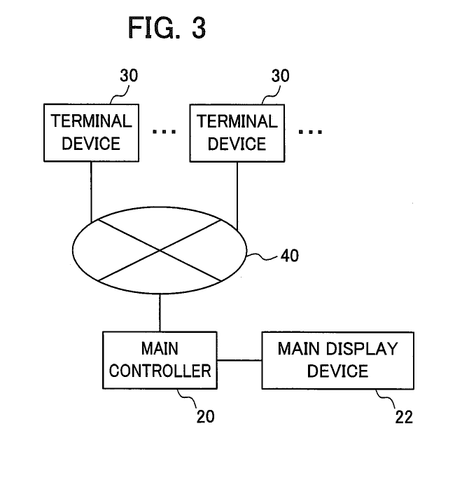

FIG. 3 is a schematic diagram showing a network of the gaming system 1.

In the gaming system 1, the main controller 20 and the plurality of terminal devices 30 can communicate with each other via a communication line to form a network 40. The main display device 21 is configured to be controlled from the main controller 20. The communication line can provide a wired or wireless connection.

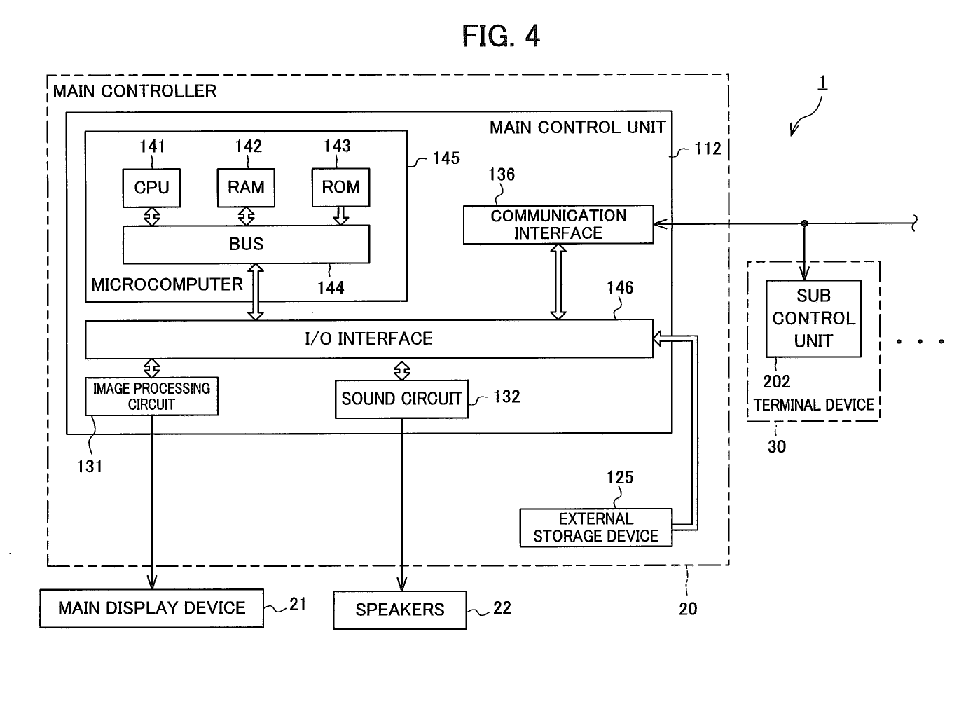

FIG. 4 is a block diagram showing the configuration of a main control unit 112 included in the main controller 20. Basically, the main control unit 112 is constituted mainly of a microcomputer 145 having a CPU 141, RAM 142, ROM 143, and a bus 144 for data transfer therebetween. The RAM 142 and the ROM 143 are connected to the CPU 141 via the bus 144. The ROM 143 stores various programs for processing required for the control of the gaming machine 1, data tables, and the like.

The RAM 142 is memory for temporarily storing various data computed by the CPU 141. In addition, the main control unit 112 can store bet information received from the plurality of terminal devices 30. The bet information includes at least one of a first bet and a second bet, where the first bet is a bet on each character and the second bet is a side bet. The side bet is the second bet placed on a payout amount for the first bet. Unlike a payout for the first bet (a first payout), a payout for the side bet (a second payout) is determined to be of a predetermined proportion with respect to the greatest payout amount for the first bet. In the present embodiment, a threshold for the greatest payout amount is defined, and a payout for a side bet is provided in a case where the greatest payout amount is greater at least the threshold value. The payout for a side bet is determined to be of a predetermined proportion with respect to the greatest payout amount, where the predetermined proportion is determined in accordance with a bet amount for the side bet. In the present embodiment, a plurality of bet amounts is defined in advance. The greater the bet amount, the higher the proportion. In the present embodiment, for example, the bet amounts of 1, 5, and 10 credits are defined for the side bet. The payout amount for the side bet corresponding thereto are 1, 5 and 10 percent of the greatest payout amount for the first bet, respectively.

An image processing circuit 131 is connected to the microcomputer 145 via an I/O interface 146. The image processing circuit 131 is connected to the main display device 21 and controls the operation thereof.

The image processing circuit 131 is constituted of: program ROM; image ROM; an image control CPU; work RAM; a video display processor (VDP); video RAM; and the like. The program ROM stores an image control program and various selection tables related to the display on the main display device 21. The image ROM stores pixel data for forming an image, such as pixel data for forming an image on the main display device 21. The image control CPU determines an image to be displayed on the main display device 21 from pixel data prestored in the image ROM based on a parameter defined by the microcomputer 145 and in accordance with an image control program prestored in the program ROM. The work RAM functions as a temporary storage device for executing the image control program by the image control CPU. The VDP generates image data according to the display content determined by the image control CPU, and outputs the same to the main display device 21. The video RAM functions as a temporary storage device to be used for forming an image by the VDP.

A sound circuit 132 is connected to the microcomputer 145 via the I/O interface 146. A speaker device 22 is connected to the sound circuit 132. The speaker device 22 generates various sound effects, BGM and the like for implementing various effects, based on a driving signal from the CPU 141 and with an output control by the sound circuit 132.

An external storage device 125 is connected to the microcomputer 145 via the I/O interface 146. The external storage device 125 operates similarly to the image ROM in the image processing circuit 131, in a case in which pixel data for forming an image, such as pixel data for forming an image on the main display device 21, is stored therein. Therefore, the image control CPU in the image processing circuit 131 selects an image to be displayed on the main display device 21 also from pixel data prestored in the external storage device 125.

A communication interface 136 is connected to the microcomputer 145 via the I/O interface 146. A sub control unit 202 of each terminal device 30 is connected to the communication interface 136. This allows for two-way communication between the CPU 141 and each terminal device 30. The CPU 141 can transmit/receive instructions, requests, data and the like with respect to each terminal device 30 via the communication interface 136. Therefore, the main controller 20 of the gaming system 1 controls the progress of a horse racing game, in cooperation with each terminal device 30.

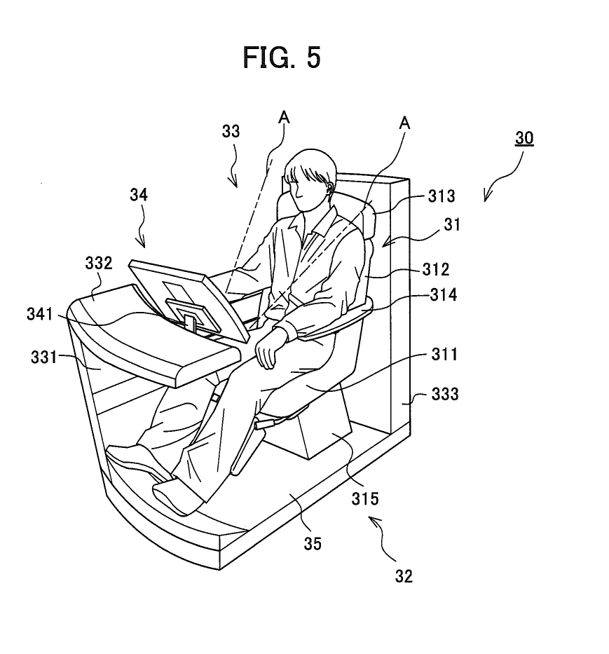

FIG. 5 is a perspective view showing an appearance of each terminal device 30. The terminal device 30 includes: a seat 31 on which a player can sit; an opening 32 formed on one of four lateral faces of the terminal device 30; a seat encircling portion 33 that covers three of four lateral faces of the terminal device 30 except for the lateral face having the opening 32; and a sub display device 34 installed on the seat encircling portion 33, in the front portion of the terminal device 30, that displays images related to the game.

The seat 31 includes: a seating surface 311 on which a player sits; a backrest 312 supporting the back of a player; a headrest 313 installed on top of the backrest 312; armrests 314 installed on both sides of the backrest 312; and a leg portion 315 fixed to the base portion 35.

The seat encircling portion 33 includes: a side unit 331 installed on an opposite face to the lateral face having the opening 32; a front unit 332 installed in the front portion of the terminal device 30; and a back unit 333 installed in the rear portion of the terminal device 30. This allows for a player to sit on and get out of the seat 31 through the opening 32, in which the seat encircling portion 33 is not formed.

A medal slot into which medals corresponding to credits are inserted, a medal payout opening that pays out medals corresponding to credits, and the like are installed on the side unit 331 (not shown). It should be noted that the gaming medium used in the present embodiment is medals; however, the present invention is not limited thereto. Examples of the gaming medium include coins, tokens, electronic money, or any equivalent valuable information such as electronic credit. In this case, credits can be paid out by a ticket printed out from a ticket printer 216 (described later).

The front unit 332 is a table having the base portion 35 and a substantially horizontal top board, which is movably supported on the side unit 331, in the front portion of the terminal device 30. Players sitting on the seat 31 can put their legs into a room under the front unit 332.

The back unit 333 is integrated with the side unit 331 and constitutes a part of the seat encircling portion 33.

The sub display device 34 includes a supporting arm 341 supported by the front unit 332 and a rectangular liquid crystal monitor 342 for displaying, fixed at the distal end of the supporting arm 341. The liquid crystal monitor 342 is a so-called touch panel, and provided at a position facing the chest of a player sitting on the seat 31. The liquid crystal monitor 342, which is a touch panel, serves as an input device used by a player to bet.

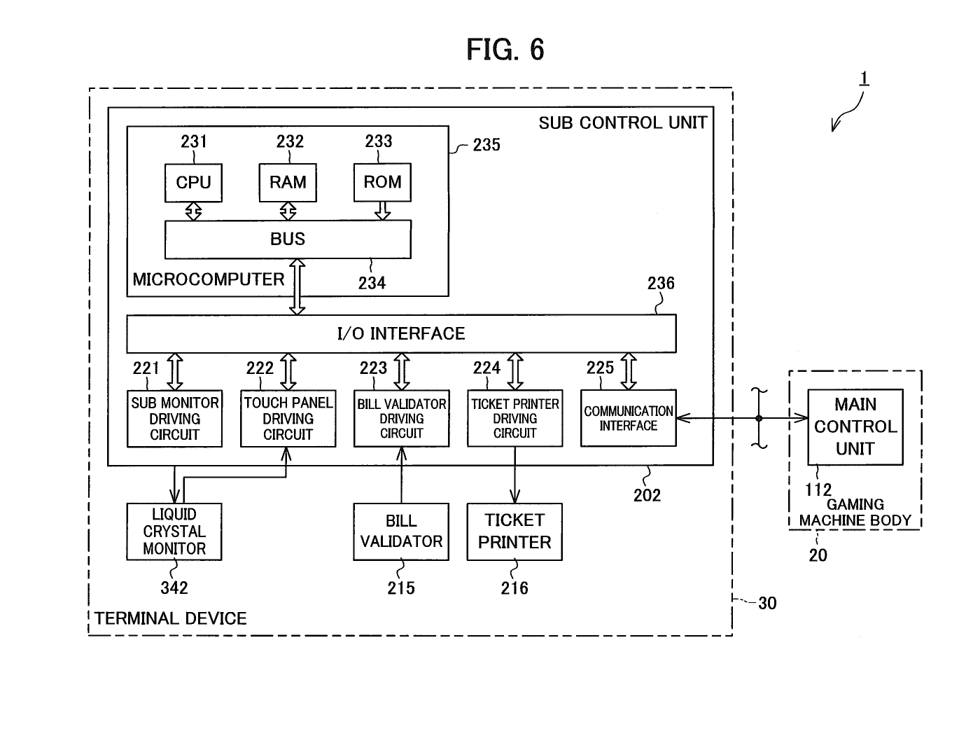

FIG. 6 is a block diagram showing the configuration of a sub control unit 202 included in the terminal device 30. The sub control unit 202 controls the terminal device 30 and is basically constituted mainly of a microcomputer 235 having a CPU 231, RAM 232, ROM 233, and a bus 234 for data transfer therebetween. The RAM 232 and the ROM 233 are connected to the CPU 231 via the bus 234. The RAM 232 is memory for temporarily storing various data computed by the CPU 231. The ROM 233 stores various programs for processing required for the control of the gaming system 1, data tables, and the like.

A sub monitor driving circuit 221 is connected to the microcomputer 235 via the I/O interface 236. A liquid crystal monitor 342 is connected to the sub monitor driving circuit 221. The sub monitor driving circuit 221 controls the operation of the liquid crystal monitor 342 based on a driving signal from a main gaming machine body 20.

A touch panel driving circuit 222 is connected to the microcomputer 235 via the I/O interface 146. A liquid crystal monitor 342 as a touch panel is connected to the touch panel driving circuit 222. An instruction, by way of a touching operation by a user, to the surface of the liquid crystal monitor 342 (touched position) is input to the CPU 231 based on a coordinate signal from the touch panel driving circuit 222.

A bill validator driving circuit 223 is connected to the microcomputer 235 via the I/O interface 236. A bill validator 215 is connected to the bill validator driving circuit 223. The bill validator 215 determines whether a bill or a bar coded ticket is valid or not. Upon reception of a valid bill, the bill validator 215 inputs the value thereof to the CPU 231 based upon the validating signal from the bill validator driving circuit 223. In addition, upon reception of a valid bar coded ticket, the bill validator 215 inputs the amount of credits and the like recorded therein to the CPU 231 based upon the validating signal from the bill validator driving circuit 223.

A ticket printer driving circuit 224 is connected to the microcomputer 235 via the I/O interface 146. A ticket printer 216 is connected to the ticket printer driving circuit 224. With an output control by the ticket printer driving circuit 224 based on a driving signal output from the CPU 231, the ticket printer 216 prints a bar code on a ticket, in which data such as credit amount stored in the RAM 232 are coded, and then prints out a bar coded ticket.

The communication interface 225 is connected to the microcomputer 235 via the I/O interface 236. The main control unit 112 of the main gaming machine body 20 is connected to the communication interface 225. This allows for two-way communication between the CPU 231 and the main control unit 112. The CPU 231 can transmit/receive instructions, requests, data and the like with respect to the main control unit 112 via the communication interface 225. Therefore, each terminal device 30 of the gaming system 1 controls the progress of a horse racing game, in cooperation with the main controller 20.

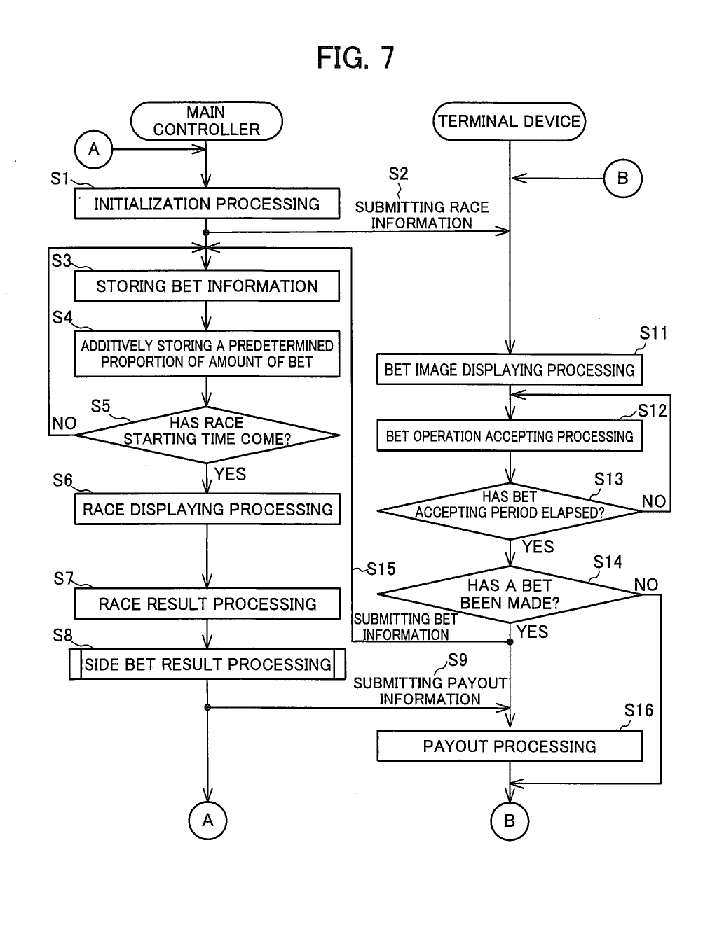

A flow of operation of the gaming system 1 is explained hereinafter with reference to the flow chart shown in FIG. 7. It should be noted that all the terminal devices 30 similarly perform a game in cooperation with the main controller 20, although a single terminal device 30 is illustrated in FIG. 7.

The main controller 20 executes processing each of Step S1 to Step S9. Firstly, in Step S1, the main control unit 112 performs initialization processing, and then the flow proceeds to Step S2. In this processing, the CPU 141 determines a course of the race, characters participating in the race, starting time and the like of the horse racing game, and reads data thereof from the ROM 143.

In Step S2, the main control unit 112 transmits race information to each of the terminal devices 30, and then advances to Step S3. In this processing, the CPU 141 transmits a course of the race, characters participating in the race, bet target team, starting time and the like, to each terminal device 30.

In Step S3, the main control unit 112 receives bet information from each terminal device 30, and stores the information in a predetermined storage region in the RAM 142, and then advances to Step S4. More specifically, this processing stores information regarding a bet on each character as the first bet and information regarding a side bet as the second bet, in a predetermined storage region in the RAM 142, for each terminal device 30.

In Step S4, the main control unit 112 additively stores a predetermined proportion of the amount of bets on characters as a resource for side bet payout, and then advances to Step S5. In this processing, the main control unit 112 accumulatively stores a predetermined proportion of the amount of bets on characters (first bet), as a resource for side bet payout, in a predetermined storage region in the RAM 142.

In Step S5, the main control unit 112 determines whether it is the time for starting the race. In the case of a YES determination, processing is advanced to Step S6 and in the case of a NO determination, processing is advanced to Step S3. More specifically, the CPU 141 checks the clock time until the time for starting the race comes, and, at the time for starting the race, advances to Step S6.

In Step S6, the main control unit 112 performs race displaying processing, and then the flow proceeds to Step S7. In this processing, the CPU 141 displays a race image on the main display device 21 and outputs sound effects and voices from the speaker device 22, based on data that is read from the ROM 143 in Step S1.

In Step S7, the main control unit 112 performs race result processing, and then the flow proceeds to Step S8. In this process, the CPU 141 computes the payout for each terminal device 30 based on the finishing order of characters participating in the race, data regarding bet information received from each terminal device 30, and the like.

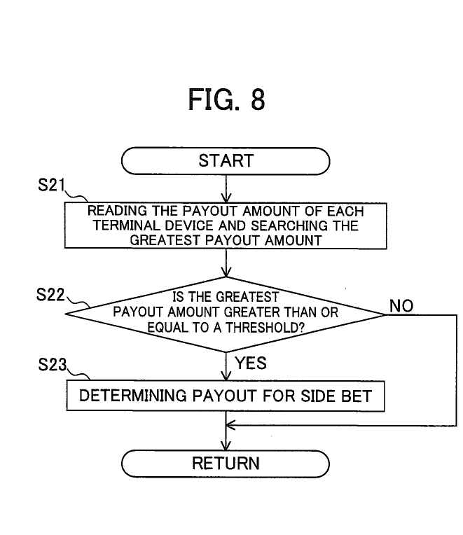

In Step S8, the main control unit 112 performs side bet result processing (described later in FIG. 8), and then advances to Step S9. In this processing, the main control unit 112 determines payout for the side bet.

In Step S9, the main control unit 112 performs payout information transmission processing, and then the flow proceeds to Step S1. In this processing, the CPU 141 transmits data regarding payout and the like computed in Steps S7 and S8 to the corresponding terminal device 30.

On the other hand, each terminal device 30 executes processing of Step S11 to Step S16. Firstly, in Step S11, the sub control unit 202 performs bet image display processing, and then the flow proceeds to Step S12. In this processing, the CPU 231 displays the odds for each racehorse, past records thereof and the like on the liquid crystal monitor 342, based on the data sent from the main controller 20 in Step S2.

In Step S12, the sub control unit 202 performs bet operation accepting processing, and then the flow proceeds to Step S13. In this processing, the CPU 231 enables touch operation by a player on the surface of the liquid crystal monitor 342 as a touch panel, starts accepting a bet operation by the player, and changes images displayed thereon in accordance with the bet operation. In the present embodiment, a bet on characters and a side bet can be made. In addition, any one of the bets can also be made.

In Step S13, the sub control unit 202 determines whether a bet accepting period has elapsed or not. In a case where this determination is YES, the flow proceeds to Step S14, and in a case where this determination is NO, Step S13 is repeated. More specifically, the CPU 231 repeatedly checks the clock time until a predetermined period has elapsed since the bet operation accepting processing started in Step S12, and, once the predetermined period has elapsed, stops accepting the bet operation by the player and advances the flow to Step S14.

In Step S14, the sub control unit 202 determines whether a bet operation was performed or not. YES for this determination leads to Step S15 and NO for this determination leads to Step S11. In this processing, the CPU 231 determines whether a bet operation has been performed in the abovementioned period in which the bet operation has been accepted.

In Step S15, the sub control unit 202 performs bet information transmission processing, and then the flow proceeds to Step S16. In this processing, the CPU 231 transmits data regarding the performed bet operation to the main controller 20.

In Step S16, the sub control unit 202 performs payout processing, and then the flow proceeds to Step S11. In this processing, the CPU 231 pays out medals from the medal payout opening, based on the data regarding payout and the like sent from the main controller 20 in Step S8.

The side bet result processing is described with reference to FIG. 8.

The side bet result processing determines a payout for the side bet.

In Step S21, the main control unit 112 reads the payout amounts for the first bets made on characters, searches for the greatest amount thereamong, and then advances to Step S22.

In Step S22, the main control unit 112 determines whether the greatest payout amount for the first bets is greater at least a threshold value, or not. In the case of a YES determination, processing is advanced to Step S23, and in the case of a NO determination, processing is advanced to Step S9 of FIG. 7. In this processing, the main control unit 112 reads the threshold value from the ROM 143 and compares the greatest payout amount searched in Step S21 against the threshold value. In a case where the greatest payout amount is greater at least a threshold value, the main control unit 112 provides a payout for the side bet.

In Step S23, the main control unit 112 determines the side bet payout for the greatest payout amount, and then advances to Step S9 of FIG. 7. This processing determines a payout for the greatest payout amount, in accordance with amount of a side bet made by each terminal device 30.

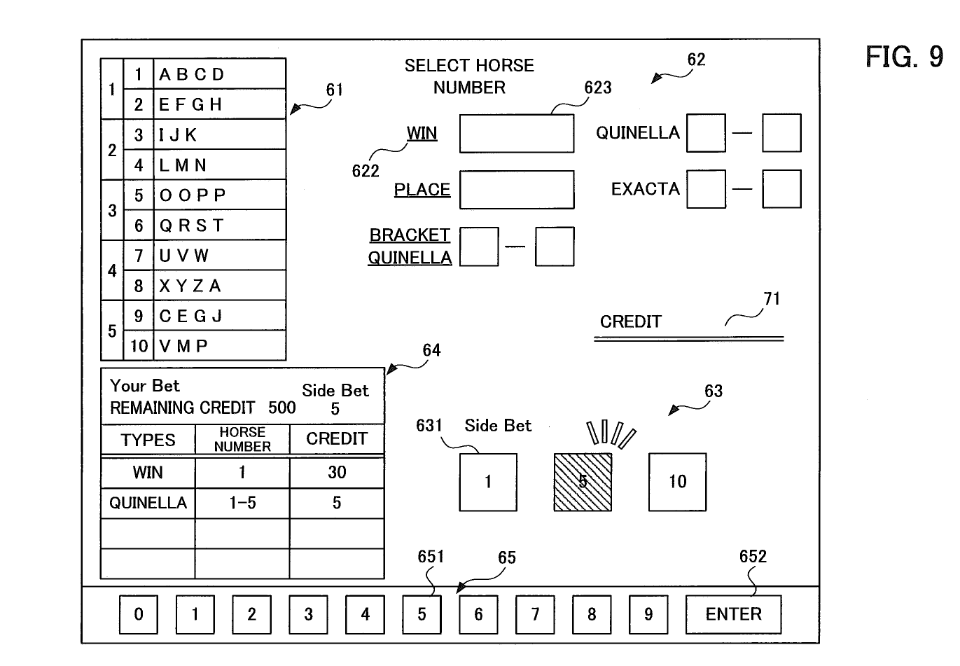

An example of a display of the bet window shown on the liquid crystal monitor 342 of the terminal device 30 is described hereinafter with reference to FIG. 9. The liquid crystal monitor 342 can be used as a touch panel, thus allowing a player to perform a bet operation by touching the touch panel according to the display thereon. In other words, the liquid crystal monitor 342 and the touch panel are an input device of the terminal device 30.

In the display example shown in FIG. 9, the bet window shown on the liquid crystal monitor 342 of the terminal device 30 is divided into 5 areas. The first area 61 displays the character number, the post position, the character name and the like of the characters participating in the race. A player can select the character to bet on with reference thereto.

The second area 62 is an area for betting. An input area is provided for each bet type that can be chosen in the racing game. The bet types can include any bet type that can be chosen in the normal horse racing games, such as Win (to predict a character winning first place) and Quinella (to predict a combination of characters in first and second places). To input, a player touches a bet type to make the bet type be in a selected state. Subsequently, a player touches a character number or a character name displayed on the first area 61 to bet thereon. For example, to make a Win bet, a player first touches an item 622 “Win”, and then touches a character number or a character name displayed on the first area. This inputs the character number touched by a player in a column 622.

The third area 63 is an area for placing a side bet. The bet amounts of 1, 5, and 10 credits are defined in advance for the side bet. A player can place a side bet by touching any one of areas 631, 632, and 633, where the bet amounts are associated to these areas. The bet amounts also represent the proportions with respect to the greatest payout amount for the bets on characters (first bets). More specifically, if the amount of the side bet is 1, a payout of 1% of the greatest payout amount is provided thereto; if the amount of the side bet is 5, a payout of 5% of the greatest payout amount is provided thereto; and if the amount of the side bet is 10, a payout of 10% of the greatest payout amount is provided thereto.

The fourth area 64 displays a list of bets made by a player. A player can check the bets they made and the remaining credits by looking at the fourth area.

The fifth area 65 is a numerical pad area. A player inputs a bet amount in the fifth area 65. A player can input a bet amount by touching a stake input area 711, and then each number key 651 displayed in a numerical pad area 65. A player can confirm the input numerical value by touching an input key 652.

### Second Embodiment

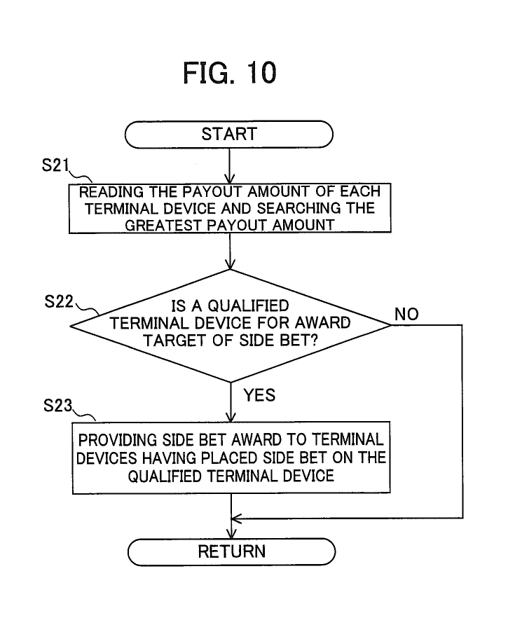

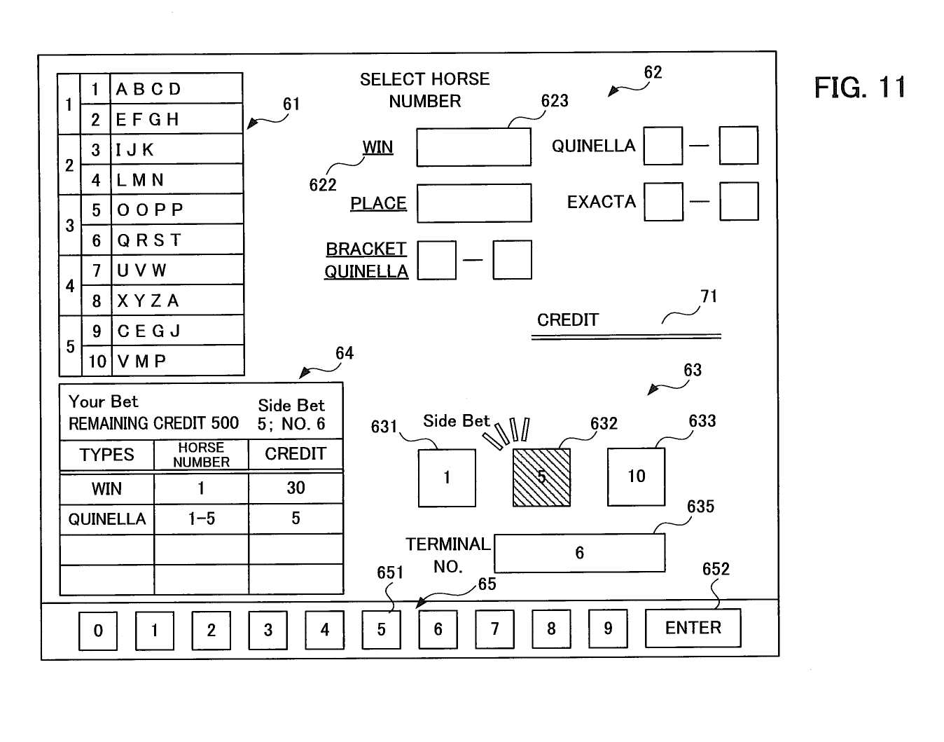

A second embodiment of the present invention is described hereinafter with reference to FIGS. 10 and 11.

The second embodiment is different from the first embodiment in that a side bet is made by designating a terminal device 30. In other words, a payout for the side bet is provided not in a case where the greatest payout amount reaches a threshold value; but in a case where a payout is provided to a designated terminal device 30 for a first bet. The payout for the side bet is a predetermined proportion with respect to the payout for the first bet.

It should be noted that the difference from the first embodiment is mainly described. Accordingly, descriptions for the same components as those in the first embodiment are omitted. In the drawings, the same components as those in the first embodiment are referenced by the same reference numbers.

FIG. 10 is a diagram showing bet result processing according to the second embodiment.

FIG. 10 is a diagram showing bet result processing according to the second embodiment. In the case of a YES determination, processing is advanced to Step S32, and in the case of a NO determination, processing is advanced to Step S9 of FIG. 7.

In Step S32, the main control unit 112 determines the side bet payout, and then advances to Step S9 of FIG. 7. In this processing, the main control unit 112 provides an award for a side bet to a terminal device 30 having placed the side bet on another terminal device 30 qualified for an award (bet target terminal). The award for the side bet is a predetermined proportion with respect to the payout amount for the first bet provided to the bet target terminal. The predetermined proportion is determined in accordance with a bet amount for the side bet, as in the first embodiment.

FIG. 11 is an example of a display of the bet window shown on the liquid crystal monitor 342 of the terminal device 30, according to the second embodiment.

In the third area, in addition to the areas 631, 632 and 633 for placing a side bet, a terminal number input area 635 for inputting a number of a terminal device 30 is provided. A player inputs a number of the terminal device 30, which is a target device of a side bet, in the terminal number input area 635. A player can input a number by touching the terminal number input area 635, each number key 651 in a numerical pad area 65 to input a number, and then an input key 652 to confirm the input number. To input a number having two or more digits, a player can touch the number keys 651 successively. For example, to input the number 35, a player touches the 3 key, the 5 key, and then the input key 652 to confirm.

After inputting the number of the target terminal device 30 and making a side bet, an amount of the side bet and the number of the terminal device 30 are displayed on a fourth area 64.

The bet information submitted to the main controller 20 by terminal devices 30 (in Step S5 of FIG. 7) includes information regarding: a first bet on each character, the amount of the side bet, and the bet target terminal of the side bet.

Subsequently, after receiving the information, the main controller 20 stores the information for each terminal device 30 (in Step S3 of FIG. 7).

In the first embodiment, a gaming system and a game control method can be provided in which a player can, in addition to betting on a certain character, bet on a payout amount provided to a player who has won an award, thus providing various betting options and increasing the chances to win an award, thereby arousing interest and excitement of the player.

In the first embodiment, a payout for the side bet is provided as an award, in a case where the greatest payout amount for the first bet reaches a threshold value. In this way, the payout for the side bet is not necessarily provided, thereby distinguishing the gambling feature of the racing game aside of the race itself.

In the second embodiment, a payout for the side bet is provided as an award to a terminal device 30 in a case where a payout for the first bet is provided to the bet target terminal, where the terminal device 30 has designated the bet target terminal device 30. A player can place a bet by predicting a terminal device to be qualified for a payout, in addition to the bet on the payout amount for a racing game.

In the first embodiment, a payout for the side bet is provided as an award, in a case where the greatest payout amount for the first bet reaches a threshold value; however, the present invention is not limited thereto. For example, a side bet payout can be provided to any greatest payout amount, without defining a threshold value. For example, in a case where a high roller has won a large bet, they can give other players an impression that they distribute a part of their revenue to others, thus creating a convivial atmosphere in the field.

In the second embodiment, a side bet is made by designating a terminal device 30; however, the present invention is not limited thereto. For example, a plurality of side bets can be made by designating a plurality of terminal devices 30 and side bet amounts thereof. In addition, the amount of the side bet is not limited to 1, 5, and 10 credits, and other amounts can also be defined.

In addition, the amount of the side bet is not limited to 1, 5, and 10 credits, and other amounts can also be defined.

While the preferred embodiments of the present invention have been described above, it should be apparent to one skilled in the art that various changes and modifications can be made without departing from the appended claims.

What is claimed is:

1. A gaming system comprising:
a display for displaying images relating to a racing game;
first memory for storing an amount of a first bet on a result of the racing game;
second memory for storing an amount of a second bet on a first payout amount determined in accordance with the result of the racing game and the first bet;
a controller for executing the racing game and for determining the first payout amount and a second payout amount determined in accordance with the second bet;
a plurality of terminals for paying out at least one of the first payout amount and the second payout amount received from the controller, wherein the plurality of terminals have an operation device for making at least one of the first bet and the second bet; and
a communication network for connecting the controller and the plurality of terminals,
wherein the controller executes steps of:
(a) receiving at least one of the amount of the first bet and the amount of the second bet from the plurality of terminals;
(b) storing one of the amount of the first bet in the first memory and the amount of the second bet in the second memory in accordance with the operation of the step (a);
(c) executing the racing game in response to the step (b);
(d) determining the first payout amount after the step (c), on the basis of a result of the racing game and the first bet stored in the first memory;
(e) determining the second payout amount in a case in which the greatest first payout amount is greater than a predetermined value; and
(f) submitting at least one of the first payout amount and the second payout amount to the plurality of terminals that are qualified for a payout.

2. The gaming system according to claim 1, wherein the second payout amount is of a predetermined proportion with respect to the greatest first payout amount.

3. A gaming system comprising:
a display for displaying images relating to a racing game;
first memory for storing an amount of a first bet on a result of the racing game;
second memory for storing an amount of a second bet on a first payout amount determined in accordance with the result of the racing game and the first bet;
a controller for executing the racing game and for determining the first payout amount and a second payout amount determined in accordance with the second bet; and
a plurality of terminals for paying out at least one of the first payout amount and the second payout amount received from the controller, having an operation device for making at least one of the first bet and the second bet; and
a communication network for connecting the controller and the plurality of terminals,
wherein the controller executes processing of:
(a) receiving at least one of the amount of the first bet and the amount of the second bet from the plurality of terminals;
(b) storing one of the amount of the first bet in the first memory and the amount of the second bet in the second memory in accordance with the step (a);
(c) executing the racing game in response to the step (b);
(d) determining the first payout amount after the step (c), on the basis of a result of the racing game and the first bet stored in the first memory;
(e) determining a value of a predetermined proportion with respect to the greatest first payout amount to be the second payout amount; and
(f) submitting at least one of the first payout amount and the second payout amount to the plurality of terminals that are qualified for a payout.

4. A gaming system comprising:
a display for displaying images relating to a racing game;
a plurality of terminals for paying out at least one of a first payout amount for a first bet and a second payout amount for a second bet, wherein the plurality of terminals have an input device for inputting at least any one of: the first bet on a result of the racing game; and the second bet on a result of the first bet together with a designation of a bet target terminal therefor;
first memory for storing the amount of the first bet for each of the plurality of terminals;
second memory for storing the amount of the second bet and information regarding the bet target terminal for each of the plurality of terminals;
a controller for executing the racing game and determining the first payout amount and the second payout amount; and
a communication network for connecting the controller and the plurality of terminals,
wherein the controller executes processing of:
(a) receiving at least one of the amount of the first bet and the amount of the second bet together with the information regarding the bet target terminal;
(b) storing the amount of the first bet in the first memory and the amount of the second bet together with the information regarding the bet target terminal in the second memory, in accordance with the operation of the step (a);
(c) executing the racing game in response to the step (b);
(d) determining the first payout amount after the step (c), on the basis of a result of the racing game and the first bet stored in the first memory;
(e) in a case in which a terminal qualified for the first payout amount is the bet target terminal, determining the second payout amount for a terminal having selected the bet target terminal, on the basis of the first payout amount for the bet target terminal and the amount of the second bet placed by a terminal selecting the bet target terminal; and
(f) submitting at least one of the first payout amount and the second payout amount to the plurality of terminals that are qualified for a payout.

5. The gaming system according to claim 4, wherein the second payout amount is of a predetermined proportion with respect to the first payout amount for the bet target terminal.

6. A method for controlling a game executed by a gaming system comprising:
a display for displaying images relating to a racing game;
first memory for storing an amount of a first bet on a result of the racing game;
second memory for storing an amount of a second bet on a first payout amount determined in accordance with the result of the racing game and the first bet;
a controller for executing the racing game and for determining the first payout amount and a second payout amount determined in accordance with the second bet; and
a plurality of terminals for paying out at least one of the first payout amount and the second payout amount received from the controller, wherein the plurality of terminals have an operation device for making at least one of the first bet and the second bet; and
a communication network for connecting the controller and the plurality of terminals, wherein
the method comprises the following steps, executed by the controller, of:
(a) receiving at least one of the amount of the first bet and the amount of the second bet from the plurality of terminals;
(b) storing one of the amount of the first bet in the first memory and the amount of the second bet in the second memory in accordance with the step (a);
(c) executing the racing game in response to the step (b);
(d) determining the first payout amount after the step (c), on the basis of a result of the racing game and the first bet stored in the first memory;
(e) determining the second payout amount in a case in which the greatest first payout amount is greater than a predetermined value; and
(f) submitting at least one of the first payout amount and the second payout amount to the plurality of terminals that are qualified for a payout.

7. The method for controlling a game according to claim 6, wherein the second payout amount is of a predetermined proportion with respect to the greatest first payout amount.

8. A method for controlling a game executed by a gaming system comprising:
a display for displaying images relating to a racing game;
a plurality of terminals for paying out at least one of a first payout amount for a first bet and a second payout amount for a second bet, the plurality of terminals having an input device for inputting at least one of: the first bet on a result of the racing game; and the second bet on a result of the first bet placed by the bet target terminal, together with a designation of a bet target terminal thereof;
first memory for storing the amount of the first bet for each of the plurality of terminals;
second memory for storing the amount of the second bet and information regarding the bet target terminal for each of the plurality of terminals;
a controller for executing the racing game and for determining the first payout amount and a second payout amount determined in accordance with the second bet; and
a communication network for connecting the controller and the plurality of terminals,
the method comprising the following steps, executed by the controller, of:
(a) receiving at least one of the amount of the first bet and the amount of the second bet together with the information regarding the bet target terminal;
(b) storing the amount of the first bet in the first memory and the amount of the second bet together with the information regarding the bet target terminal in the second memory, in accordance with the operation of the step (a);
(c) executing the racing game in response to the step (b);
(d) determining the first payout amount after the step (c), on the basis of a result of the racing game and the first bet stored in the first memory;
(e) in a case in which a terminal qualified for the first payout amount is the bet target terminal, determining the second payout amount for a terminal having selected the bet target terminal, on the basis of the first payout amount for the bet target terminal and the amount of the second bet placed by a terminal selecting the bet target terminal; and
(f) submitting at least one of the first payout amount and the second payout amount to the plurality of terminals that are qualified for a payout.

9. The method for controlling a game according to claim 8, wherein the second payout amount is of a predetermined proportion with respect to the first payout amount for the bet target terminal.
